(19) United States
(12) Patent Application Publication
(10) Pub. No.: US 2003/0000363 A1
(43) Pub. Date: Jan. 2, 2003

(54) Sawing tool for a circular handsaw machine with two coaxial sawing blades which can be driven in opposite directions and rotate past each other

(76) Inventors: Albrecht Hofmann, Steinbronn (DE); Harald Krondorfer, Ludwigsburg (DE); Thomas Schomisch, Leinfelden-Echterdingen (DE); Juergen Graef, Oberkochen (DE); Helmut Hammer, Aalen (DE); Andreas Kisselbach, Aalen (DE)

Correspondence Address: Striker Striker & Stenby, 103 East Neck Road, Huntington, NY, 11743, US

(21) Appl. No.: 10/182,511

(22) PCT Filed: Sep. 15, 2001
(86) PCT No.: PCT/DE01/03556

(30) Foreign Application Priority Data
Dec. 2, 2000 (DE) 100 59 978.8

(51) Int. Cl. B27B 33/02

(52) U.S. Cl. 83/837; 30/347; 83/664; 83/666

(57) ABSTRACT

In a sawing tool for a hand circular power saw with two coaxial saw blades (11, 12), which can be driven to counter-rotate in relation to each other, which each have an outer set of teeth (13, 14) that represents a main cutter, in order to improve the cutting result even with continuing wear on the cutting edge and in order to reduce damage to the teeth (13, 14) when the saw blades (11, 12) are imperfectly balanced, a trimmer (10) is disposed between the two saw blades (11, 12), which serves to cut away a piece of material possibly remaining in the kerf between the saw blades (11, 12) and which is non-rotatably attached to one of the saw blades (11, 12) and shares an axial overlap with the main cutters (FIG. 3).

### PRIOR ART

The invention is based on a sawing tool for a hand circular power saw with two coaxial saw blades, which can be driven to counter-rotate in relation to each other, of the generic type defined in the preamble to claim 1.

Sawing tools of this kind have the advantage that during operation of the manually guided circular power saw, the reaction forces and reaction moments are eliminated by the counter-rotation of the two saw blades and the user can guide the machine with ease and with a low amount of reaction force. With continuous wear on the cutting edge, e.g. when the cutting corners with which the two saw blades travel past each other become rounded, the saw blades no longer rest snugly against each other and the material between the two saw blades is no longer completely removed so that a piece of material remains in the kerf.

In a known sawing tool of the type mentioned at the beginning (WO 89/00474), the main cutting edges of the saw teeth are inclined in relation to the saw blade plane so that the corner edges of the main cutting edges situated further forward in the rotation direction of the saw blades are disposed on the blade sides of the saw blades that are oriented toward each other. As a result, the cutting force of the main cutting edges produces an axially oriented force component during sawing, which presses the serrated regions of the saw blades together in the cutting region so that the saw blades continue to rest snugly against each other even with increasing wear on the cutting edges.

Sawing tools of this kind, which are designed to hold the saw blades together in the kerf, have the disadvantage that the friction between the saw blades leads to relatively high friction losses that cause the saw blades to heat up a very rapidly.

### ADVANTAGES OF THE INVENTION

The sawing tool according to the invention has the advantage that the material is cut jointly by two cutters that overlap each other in the kerf. As is the case in the prior sawing tools, the main cutters, which have the usual serrations comprised of a large number of main cutter teeth that support main cutting edges and secondary cutting edges, perform most of the sawing work, while the trimmer cuts only the piece remaining between the two saw blades. In the sawing tool according to the invention, the saw blades therefore no longer need to be deliberately held together, but can also operate with an axial distance between the main cutters, which does not cancel out the overlapping of the main cutting edges and the secondary cutting edges. The trimmer cuts away material that gets in between the main cutters. Because of the trimmer, the degree of wear on the two main cutters does not have much influence on whether a piece of material remains in the kerf, because the piece is cut away by the trimmer. Since the separation of the saw blades no longer presents a problem thanks to the presence of the trimmer, in the sawing tool according to the invention, the saw blades also do not have to be held together to an excessive degree in the kerf, which means that lower frictional losses are produced and the saw blade temperature remains low.

Advantageous modifications and improvements of the sawing tool disclosed in claim 1 are possible by means of the steps taken in the remaining claims.

According to a preferred embodiment of the invention, the trimmer has a large number of cutting edges, which are radially recessed in relation to the main cutting edges of the main cutter teeth and which have an axial width that is greater than the axial distance between the main cutter teeth on the two saw blades. In this embodiment of the trimmer, an optimal cutting result is assured even with extreme cutting edge wear on the main cutters.

According to a first embodiment of the invention, the radially recessed cutting edges of the trimmer are constituted by the secondary cutting edges of the main cutter teeth of the one saw blade, which are oriented toward the other saw blade and are inclined in relation to the blade plane so that their outer edge adjoining the main cutting edge is recessed into the saw blade plane and their inner edge on the other side projects from the saw blade plane, while the secondary cutting edges of the other saw blade, which are oriented toward the trimmer, are inclined parallel to them. In a new sawing tool, the secondary cutting edges of the two saw blades oriented toward each other travel past each other with almost no gap. If, for example, due wear on the cutting corners or due to a tolerance-induced gap between the saw blades, a piece of material remains uncut during the sawing operation, this is removed by the inclined secondary cutting edges, which thereby perform the function of a trimmer.

According to an advantageous embodiment of the invention, the outer secondary cutting edges of the main cutter teeth of the saw blade, which are oriented away from the secondary cutting edges of the trimmer, are inclined so that the cutting corners that they form with the main cutting edges are recessed slightly from the saw blade plane. This inclination of the outer secondary cutting edges can absorb lateral forces produced in the trimmer.

According to an alternative embodiment of the invention, the trimmer has a large number of trimmer teeth, which each have a cutting edge and are arranged in equidistant succession in a circle concentric to the saw blade axis.

In a preferred exemplary embodiment, the trimmer teeth are disposed on the one saw blade so that they project laterally from the blade plane and protrude into a blade recess embodied in the other saw blade, directly underneath its teeth. In this exemplary embodiment, the sharp cutting corners of the main cutting surfaces of the two saw blades are prevented from colliding with one another and causing malfunctions as a result of axial pressure on the saw blades or poor balance in the two saw blades due to unfavorable tolerances. Instead, when lateral forces occur, the side surfaces of the trimmer teeth travel against the bottom of the blade recess without being damaged and thus restrict the collision of the saw blades.

According to an advantageous embodiment of the invention, the blade recess is embodied as an annular groove, which is concentric to the saw blade axis and is provided with a friction-reducing coating.

According to an advantageous embodiment of the invention, the trimmer teeth are disposed inside the teeth of the main cutter, between the main cutter teeth, and have a smaller tooth height than the main cutter teeth. Since the trimmer teeth only perform a small portion the cutting work, advantageously fewer trimmer teeth are provided than main cutter teeth so that, for example, one trimmer tooth is provided only after every second or third main cutter tooth.

For the same reason of the trimmer teeth performing less of the cutting work, according to an advantageous embodiment of the invention, the trimmer teeth are comprised of a softer and therefore less expensive material than the main cutter teeth and can, for example, be set out from the saw blade. The set trimmer teeth are then ground in the cutting region.

According to an advantageous embodiment of the invention, the main cutter teeth of the saw blade, which has the trimmer teeth, are embodied as narrower in the axial direction than the main cutter teeth of the other saw blade. With a suitable dimensioning, the torque required for sawing remains approximately equal in the two saw blades and no imbalance is produced by the insetting of the trimmer teeth, thus preserving the virtually reaction force-free sawing with the manually guided circular saw.

According to an alternative embodiment of the invention, at least one coaxial friction ring is disposed between the saw blades and its axial thickness is slightly greater than the distance that the trimmer teeth project from the saw blade plane. This friction ring absorbs the friction of the counter-rotating saw blades when the saw blades are pressed together in the work piece so that the trimmer teeth are relieved of the friction against the opposite saw blade and less heat is produced in the kerf.

According to alternative embodiments of the invention, the at least one friction ring can travel freely between the saw blades; it is preferably guided against the lower edge of the trimmer teeth or against the drive spindle of the saw blade, or the friction ring is fastened to one of the saw blades, e.g. by means of spot welding, rivets, glue, etc. In addition, the surface of the at least one friction ring is advantageously optimized in terms of its sliding properties through materials selection or by means of a suitable coating.

According to an advantageous embodiment of the invention, the trimmer teeth of the trimmer are disposed on a separate annular or disk-shaped support, which is non-rotatably attached to one of the saw blades. This has the advantage that the trimmer can be produced without having to make changes to the saw blades. Grooves and projections on the saw blades are eliminated, which minimizes grinding costs and wobble. In addition, a complex soldering-on and grinding of hard metal cutting edges on different saw blade radii (main cutter teeth on the outside, trimmer teeth further inside).

According to an advantageous embodiment of the invention, a friction-reducing coating is provided on the free support side of the support or on the blade side of the other saw blade oriented toward this support side.

According to an advantageous embodiment of the invention, the trimmer teeth are made of the material of the support, for which e.g. super-speed steel or tool steel is then used, or are embodied as separate, soldered-on teeth made of another material, e.g. hard metal.

According to an advantageous embodiment of the invention, the saw blade, which has the support with the trimmer teeth fastened to it, is provided with means, e.g. channels, by means of which the material cuttings produced by the trimmer teeth can be carried away.

### DRAWINGS

The invention will be explained in detail in the description below in conjunction with exemplary embodiments shown in the drawings.

FIG. 1 shows a top view of a sawing tool with two counter-rotating circular saw blades,

FIG. 2 shows a detail of a section along the line II-II in FIG. 1,

FIG. 3 shows an enlargement of the detail III in FIG. 2, when the saw blade is engaging a work piece,

FIG. 4 shows a longitudinal section through a sawing tool according to a second exemplary embodiment,

FIG. 5 shows a detail of a perspective view of the sawing tool in FIG. 4,

FIG. 6 shows a detail of a longitudinal section through a sawing tool according to a third exemplary embodiment,

FIG. 7 shows a perspective view of two friction rings that are provided in the sawing tool according to FIG. 6,

FIG. 8 shows a detail of a longitudinal section through a sawing tool according to a fourth exemplary embodiment,

FIG. 9 shows a detail of a top view of a sawing tool according to a fifth exemplary embodiment,

FIG. 10 shows a detail of a top view of the sawing tool saw blade that is hidden in FIG. 9,

FIG. 11 shows a detail of a section along the line XI-XI in FIG. 9,

FIG. 12 shows an enlargement of the detail XII in FIG. 11.

### DESCRIPTION OF THE EXEMPLARY EMBODIMENTS

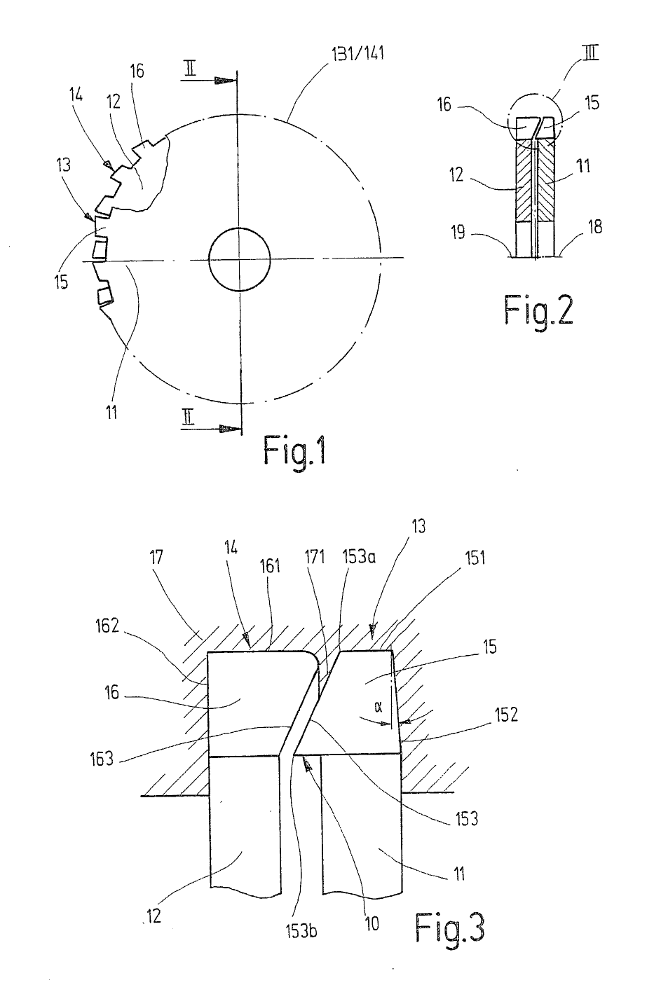

The sawing tools for a hand circular power saw, which are shown in various views and sections in the drawings, each have two coaxial circular saw blades, which can be driven to counter-rotate in relation to each other, referred to below as saw blades 11, 12, which after being clamped into the tool holding fixture of a hand circular power saw, not shown here, are each non-rotatably connected to one of two concentrically disposed counter-rotating drive spindles. Each saw blade 11, 12 has an external set of teeth 13, 14, referred to below as the main cutter, comprised of the large number of main cutter teeth 15, 16. Each main cutter tooth 15, 16 has a main cutting edge 151, 161, an outer secondary cutting edge 152, 162, and an inner secondary cutting edge 153, 163; the inner secondary cutting edges 153, 163 of the two saw blades 11, 12 are oriented toward each other (FIG. 3). FIG. 1 shows only a detail of the sets of teeth 13, 14 of the two saw blades 11, 12; otherwise, each set of teeth 13, 14 is symbolized by its reference circle 131, 141. Between the two saw blades 11, 12, there is a so-called trimmer 10, which is non-rotatably attached to one of the saw blades 11, 12 and shares an axial overlap with the main cutter teeth 15, 16. The trimmer 10 has a large number of cutting edges, which are radially recessed in relation to the main cutting edges 151, 161 of the main cutter teeth 15, 16 and have an axial width that is greater than the reciprocal axial distance between the main cutter teeth 15, 16 on the two saw blades 11, 12. The trimmer 10 is used to cut away a piece of material 171 (FIG. 3), which possibly remains between the saw blades 11, 12 during sawing and can result when there is a large axial gap between the main cutter teeth 15, 16 due to wear of the main cutting edges 151, 161 and due to axial tolerances.

In the exemplary embodiment shown in FIGS. 1 to 3, the cutting edges of the trimmer 10 are constituted by the inner secondary cutting edges 153 of the main cutter teeth 15 of the saw blade 11, which are oriented toward the saw blade 12 and are inclined in relation to the saw blade plane so that their outer edge 153a adjoining the main cutting edge 151 is recessed from the saw blade plane and their inner edge 153b at the other end projects from the saw blade plane. The inner secondary cutting edges 163 of the other saw blade 16 oriented toward the trimmer 10 are inclined parallel to them. FIG. 2 shows a detail of a longitudinal section through a new sawing tool. The inner secondary cutting edges 153 and 163 of the main cutter teeth 15, 16 rotate past each other with almost no gap between them. FIG. 3 shows an enlargement of the detail III in FIG. 2 of the sawing tool, which has already experienced a degree of wear. As a result of the wear, a piece of material 171 remains in the kerf cut into the work piece 17 during the sawing process; this piece of material 171 is then cut away by the inner secondary cutting edges 153 of the main cutter teeth 15 in their function as a trimmer 10. Under some circumstances, lateral forces produced in the trimmer 10 are absorbed by an inclination of the outer secondary cutting edges 152 of the saw blade 12 supporting the trimmer 10. The inclination angle here is chosen so that the cutting corner formed with the main cutting edge 151 is recessed slightly from the saw blade plane. The inclination angle of the outer cutting edges 152 is labeled α in FIG. 2.

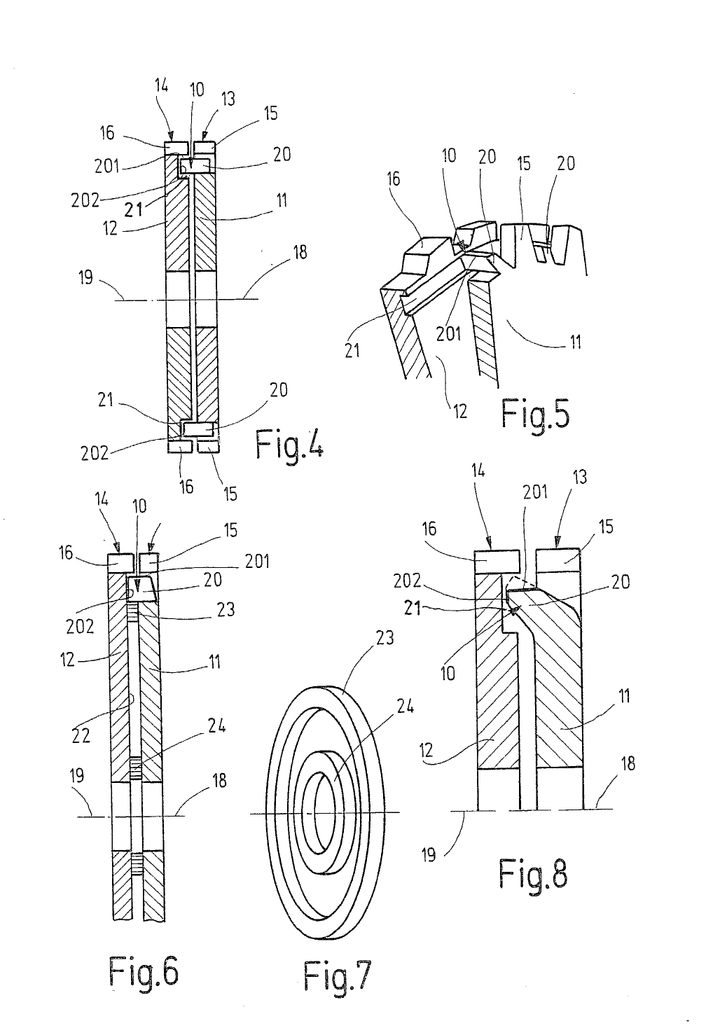

In the exemplary embodiment of the sawing tool according to FIGS. 4 and 5, the trimmer 10 has a large number of trimmer teeth 20, which each have a cutting edge 201 and are arranged in succession in a circle concentric to the coinciding saw blade axes 18, 19. The trimmer teeth 20 are embodied on the saw blade 11 so that they project laterally from the saw blade plane and protrude into an annular groove 21, which is concentric to the saw blade axis 19 and is embodied in the saw blade 12 directly under its teeth 14. As a result, the axial width of the trimmer teeth 20 and therefore of its cutting edges 201, is greater than the maximal possible distance between the main cutter teeth 15 and 16 of the sawing tool during the sawing process. In addition, when an axial pressure on the sawing tool occurs during the sawing process, the saw blade 11 is supported by means of the side surfaces 202 of the trimmer teeth 20 in the groove base of the annular groove 21 so that the sharp cutting corners of the two saw blades 11, 12 are reliably prevented from colliding during operation, which would severely damage them. In order to reduce friction, at least the groove bottom of the annular groove 21 is provided with a friction-reducing coating. As the perspective view in FIG. 5 shows, the trimmer teeth 20 are disposed between cutter teeth 15 of the saw blade 11 and have a lower tooth height than the main cutter teeth 15.

In this embodiment of the trimmer 10, the teeth 13, 14 of the two saw blades 11, 12, functioning as main cutters, perform virtually all of the sawing work, which is split in half between the two of them, and by contrast the trimmer teeth 20, with their recessed cutting edges 201, cut only a piece of material possibly remaining between the main cutter teeth 15, 16. Since the trimmer teeth 20 perform significantly less cutting work, fewer trimmer teeth 20 than main cutter teeth 15 can be provided. Instead of one trimmer tooth 20 being disposed between every other main cutter tooth 15, as shown in FIG. 5, one trimmer tooth 20 can be provided only after every second or third main cutter tooth 15. For the same reason, the trimmer teeth 20 can also be made of softer and therefore less expensive material than the main cutter teeth 15. Therefore the trimmer teeth 20, as shown in the exemplary embodiment according to FIG. 8, can be worked from the saw blade 15 by means of setting and can be ground in the cutting region and on the side surface 202 that protrudes into the annular groove 21.

In the exemplary embodiment of the sawing tool depicted in FIGS. 6 and 7, the thickness of the saw blade 12 in the region of the saw blade 12 underneath the circumferential set of teeth 14 is reduced as a whole, which produces a recess 22 enclosed by the ring of teeth. The trimmer teeth 20, which are disposed on the saw blade 11 and project from its blade plane, protrude into this recess 22. In contrast to the sawing tool according to FIGS. 4 and 5, an axial force acting on the sawing tool during sawing is achieved not by the support of the side surfaces 202 of the trimmer teeth 20 against the saw blade 12, but by means of two friction rings 23, 24, which are disposed between the two saw blades 11, 12 and have an axial thickness that is slightly greater than the distance that the trimmer teeth 20 project from the blade plane of the saw blade 11. The two friction rings 23, 24 are loosely supported between the saw blades 11, 12; the outer friction ring 23 is guided against the bottom edge of the trimmer teeth 20 and the inner friction ring 24 is supported on one of the drive spindles (not shown here) that support the saw blades 11, 12. However, the two friction rings 23, 24 can also be fastened to the saw blade 11 or the saw blade 12, e.g. by means of spot welding, rivets, glue, etc. In order to minimize friction, the surfaces of the two friction rings 23, 24 are the optimized in terms of their sliding properties through materials selection or by means of a suitable coating.

As shown in FIG. 6, the main cutter teeth 15 of the saw blade 11 supporting the trimmer teeth 20 are embodied so that they are narrower in the axial direction than the main cutter teeth 16 on the saw blade 15. As a result, with suitable dimensioning of the main cutter teeth 15, the torque required for sawing remains approximately equal in the two saw blades 11, 12 and no imbalance is produced by the insetting of the trimmer teeth 20. This preserves the advantageous, virtually reaction force-free sawing with the end circular power saw.

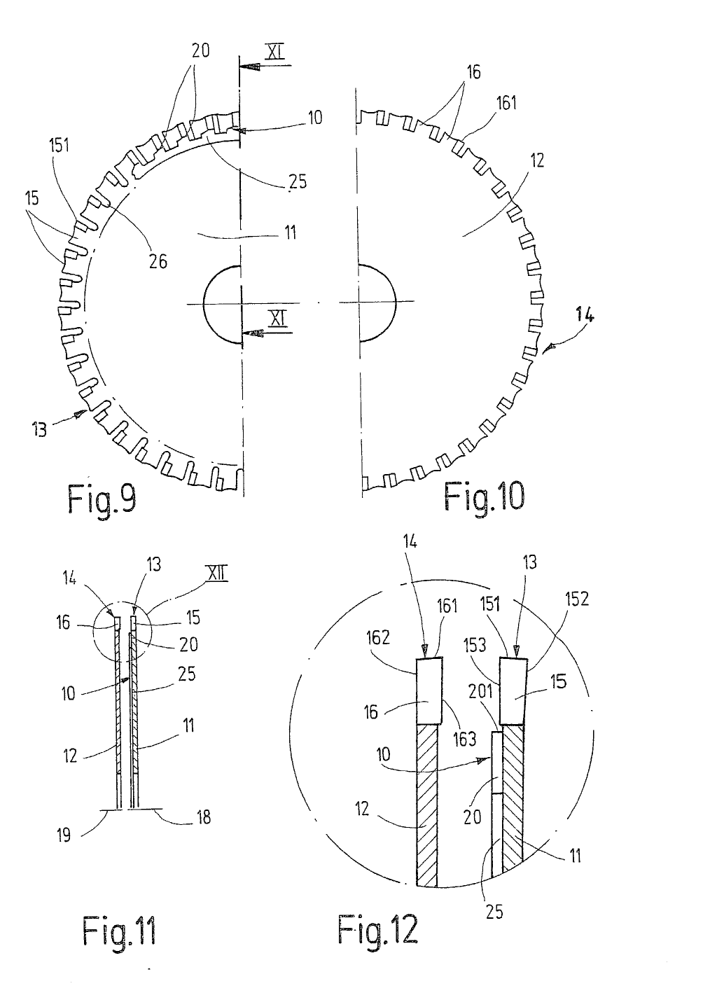

In exemplary embodiment of the sawing tool according to FIGS. 9 to 12, the trimmer 10 is embodied as a separate component and is non-rotatably attached to the saw blade 11. The trimmer teeth 20 are disposed equidistantly along the circumference of a support 25, which is annular in this exemplary embodiment, but can also be alternatively embodied as a disk. The support 25 is attached to the saw blade 11 so that the cutting edges 201 of the trimmer teeth 20 are disposed approximately at the same height as the bottom of the teeth of the main cutter teeth 15. Each tooth bottom is recessed by a radially extending channel 26, which extends past the radial width of the annular support 25. The large number of channels 26 serves to carry away the cuttings produced by the trimmer teeth 20 during the sawing process.

FIG. 9 shows a detail of the saw blade 11 and the annular support 25 fastened to it, with its circumferentially arranged trimmer teeth 20. FIG. 10 shows a detail of the other saw blade 12, which has the main cutter teeth 16 and which—as the sectional depiction in FIG. 11 indicates—is disposed coaxial to the saw blade 11 and the support 25; the annular support 25 is disposed between the two saw blades 11, 12. The axial distance between the two saw blades 11, 12 is depicted in a very exaggerated form for the sake of clarity in FIGS. 11 and 12. The actual distance is smaller. When an axial force that presses the saw blades 11, 12 together occurs during the sawing process, the annular support 25 is supported axially against the blade plane of the saw blade 12. In order to reduce the friction that is generated as a result, the support 25 or the saw blade 12 is provided with a friction-reducing coating on the sides oriented toward each other. The axial thickness of the support 25 is chosen so that when the support 25 rests against the saw blade 12, the inner cutting edges 153 and 163 on the saw blades 11 and 12 that are oriented toward each other can rotate past each other.

The trimmer teeth 20 are preferably worked from the material of the support 25, which is comprised, for example, of super-speed steel or tool steel. The trimmer teeth 20, however, can also be soldered onto the support as separate teeth made of a different material, e.g. hard metal. The advantage of the latter sawing tool over the sawing tools described previously in conjunction with FIGS. 1 to 8 is that the support 25 can be manufactured with a constant axial thickness and no grooves or steps are required in the saw blades 11, 12. On the one hand, this minimizes the so-called wobble of the sawing tool and on the other hand, it reduces the costs for manufacturing it, particularly those incurred by grinding work.

1. A sawing tool for a hand circular power saw with two coaxial saw blades (11, 12), which can be driven to counter-rotate in relation to each other, which each have an outer set of teeth (13, 14), which represents a main cutter and is comprised of a large number of main cutter teeth (15, 16) that support main cutting edges and secondary cutting edges (151, 152, 153, 161, 162, 163), characterized in that a trimmer (10) is disposed between the two saw blades (11, 12), which serves to cut away a piece of material possibly remaining in the kerf between the saw blades (11, 12) and which is non-rotatably attached to one of the saw blades (11, 12) and shares an axial overlap with the main cutter teeth (15, 16).

2. The sawing tool according to claim 1, characterized in that the trimmer (10) has a large number of cutting edges (201; 153), which are radially recessed in relation to the main cutting edges (151, 161) of the main cutter teeth (15, 16) and which have an axial width that is greater than the reciprocal axial distance between the main cutter teeth (15, 16) on the two saw blades (11, 12).

3. The sawing tool according to claim 2, characterized in that the cutting edges of the trimmer (10) are constituted by the secondary cutting edges (153) of the main cutter teeth (15) of the one saw blade (11), which are oriented toward the other saw blade (12) and are inclined in relation to the blade plane so that their outer edge (153a) adjoining the main cutting edge (151) is recessed into the saw blade plane and their inner edge (153b) on the other side projects from the saw blade plane, and that the secondary cutting edges (163) of the other saw blade (12), which are oriented toward the trimmer (10), are inclined parallel to them.

4. The sawing tool according to claim 2, characterized in that the trimmer (10) has a large number of trimmer teeth (20), which each have a cutting edge (201) and are arranged in succession in a circle concentric to the saw blade axes (18, 19).

5. The sawing tool according to claim 4, characterized in that the trimmer teeth (20) are disposed on the one saw blade (11) so that they project laterally from the blade plane and protrude into a blade recess embodied in the other saw blade (12), directly underneath its teeth (14).

6. The sawing tool according to claim 5, characterized in that the blade recess is embodied as an annular groove (21), which is concentric to the saw blade axis (19) and is preferably provided with a friction-reducing coating.

7. The sawing tool according to claim 5 or 6, characterized in that the trimmer teeth (20) are disposed inside the set of teeth (13), between the main cutter teeth (15), and have a smaller tooth height than the main cutter teeth (15).

8. The sawing tool according to one of claims 5 to 7, characterized in that the main cutter teeth (15) of the saw blade (11), which has the trimmer teeth (20), are embodied as narrower in the axial direction than the main cutter teeth (16) of the other saw blade (12).

9. The sawing tool according to one of claims 5 to 8, characterized in that at least one coaxial friction ring (23, 24) is disposed between the saw blades (11, 12)and its axial thickness is slightly greater than the distance that the trimmer teeth (20) project from the blade plane of the saw blade (11).

10. The sawing tool according to claim 4, characterized in that the trimmer teeth (20) are disposed on a separate annular or disk-shaped support (25), which is non-rotatably attached to one of the saw blades (11, 12), and preferably that the support (25) is provided with a friction-reducing coating on its free support side oriented toward the other blade (12).
